(19) United States
(12) Patent Application Publication
(10) Pub. No.: US 2021/0011660 A1
(43) Pub. Date: Jan. 14, 2021

(54) INFORMATION PROCESSING APPARATUS AND CONTROL METHOD

(71) Applicant: CANON KABUSHIKI KAISHA, Tokyo (JP)

(72) Inventor: Shinichi Ono, Tokyo (JP)

(21) Appl. No.: 16/918,266

(22) Filed: Jul. 1, 2020

(30) Foreign Application Priority Data
Jul. 8, 2019 (JP) 2019-127088

(51) Int. Cl. G06F 3/06; G06F 13/40; G06F 9/4401

(52) U.S. Cl. CPC G06F 3/0659; G06F 3/0619; G06F 9/4403; G06F 13/4022; G06F 3/0673

(57) ABSTRACT

There is provided an information processing apparatus including: a storage configured to store a program; a first processor configured to output a first control signal and to determine whether the program read out from the storage in accordance with the first control signal is valid; a second processor configured to output a second control signal and to execute the program read out from the storage in accordance with the second control signal; and a first switch configured to selectively output one of the first control signal and the second control signal to the storage.

### BACKGROUND OF THE INVENTION

### Field of the Invention

The present disclosure generally relates to an information processing apparatus, and more particularly, to control of execution of a program in an information processing apparatus.

### Description of the Related Art

To detect alteration of a program such as a boot code embedded in information equipment, there is known a method in which an auxiliary processor for verifying validity of a program before execution of the program by a main processor is provided in information equipment (see Japanese Patent Laid-Open No. 2014-021953).

In general, a program executed when activating or initializing a system is stored in advance in a dedicated storage device. In the above-described alteration detection method, the auxiliary processor first accesses the storage device to verify validity of the program. After the verification succeeds, the main processor accesses the same storage device to execute the program. Each of these processors normally operates as a master for communication when reading out the program from the storage device, and the storage device operates as a slave.

Japanese Patent Laid-Open No. 2001-175588 discloses a mechanism in which, in an arrangement including a plurality of master devices and a plurality of slave devices, a bus controller existing between the masters and the slaves manages access requests in a queue, thereby ensuring an access order.

### SUMMARY OF THE INVENTION

Additional implementation of a controller for performing complicated queue management to verify validity of a program excessively increases the circuit scale and increases the manufacturing cost. On the other hand, if a bus for an access request to one slave device is simply branched and connected to a plurality of master devices, conflict of signals from the master devices on the bus may cause an operation failure. These problems are similarly present in a case where information equipment is to be protected not only against alteration of a program but also against deterioration of program data.

Therefore, there is a demand for provision of an improved mechanism for verifying validity of a program.

According to an aspect, there is provided an information processing apparatus including: a storage configured to store a program; a first processor configured to output a first control signal and to determine whether the program read out from the storage in accordance with the first control signal is valid; a second processor configured to output a second control signal and to execute the program read out from the storage in accordance with the second control signal; and a first switch configured to selectively output one of the first control signal and the second control signal to the storage. A corresponding method is also provided.

Further features of the present invention will become apparent from the following description of exemplary embodiments (with reference to the attached drawings).

### BRIEF DESCRIPTION OF THE DRAWINGS

FIG. 1 is a block diagram showing an example of a schematic arrangement of an MFP according to an embodiment;

FIG. 2 is a block diagram showing an example of a practical arrangement of a main CPU according to an embodiment;

FIG. 3 is a block diagram showing an example of a practical arrangement of a sub-CPU according to an embodiment;

FIG. 4 is a view showing an example of a memory map of a flash ROM according to an embodiment;

FIG. 5 is a block diagram showing an example of a detailed arrangement of an SPI bus according to an embodiment;

FIG. 6 is a timing chart showing flows of control signals on an SPI bus according to an embodiment;

FIG. 7 is a flowchart illustrating an example of a schematic procedure of control processing according to an embodiment;

FIG. 8 is a flowchart illustrating an example of a detailed procedure of control processing executed by a sub-CPU according to an embodiment; and

FIG. 9 is a flowchart illustrating an example of a detailed procedure of control processing executed by a main CPU according to an embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### 1. Example of Arrangement of Apparatus

### 1-1. Overall Arrangement

This section will describe an example in which a technique according to the present disclosure is applied to a digital MFP (Multi-Function Peripheral). The digital MFP will also be simply referred to as an MFP hereinafter. However, the technique according to the present disclosure is not limited to an MFP, and may be applied to any kind of information processing apparatus. Unless otherwise specified, each component such as an apparatus, a device, a module, or a chip to be described below may be formed by a single entity or a plurality of physically different entities.

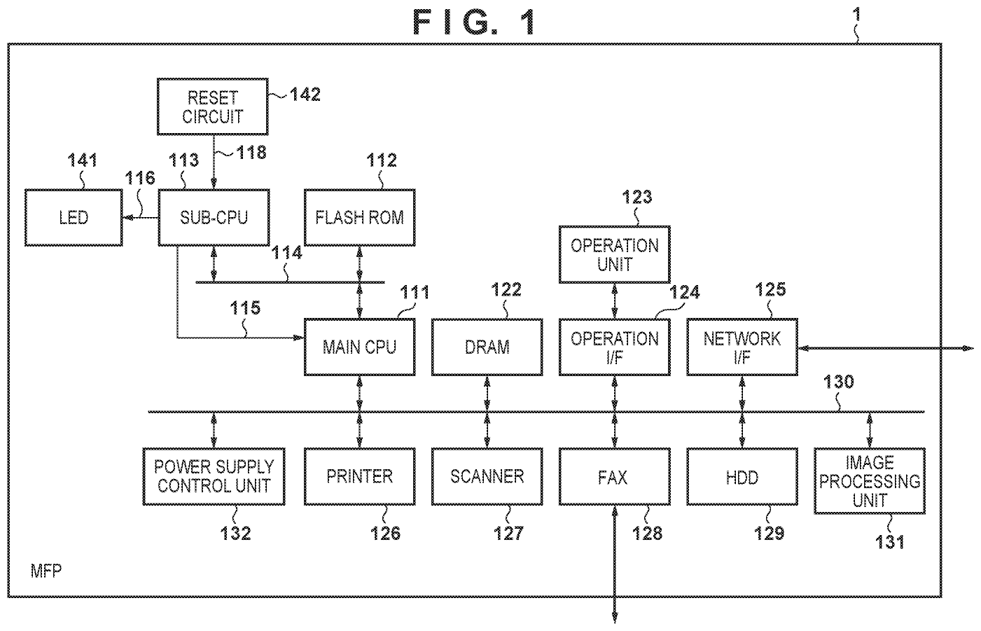

FIG. 1 is a block diagram showing an example of a schematic arrangement of an MFP 1 according to an embodiment. Referring to FIG. 1, the MFP 1 includes a main CPU (Central Processing Unit) 111, a flash ROM (Read Only Memory) 112, and a sub-CPU 113. The main CPU 111 is a processor that controls general functions of the MFP 1. The flash ROM 112 is a storage device that stores one or more programs to be executed by the main CPU 111, and defined setting values for basic settings of the MFP 1. The programs stored in the flash ROM 112 include, for example, boot programs (for example, a BIOS (Basic Input Output System) and a boot loader) for booting the main CPU 111. Some programs (for example, an operating system and programs for various applications) to be executed by the main CPU 111 may be stored in a storage device (for example, an HDD 129 (to be described later)) different from the flash ROM 112. The sub-CPU 113 is an auxiliary processor that verifies validity of a program stored in the flash ROM 112 before execution by the main CPU 111.

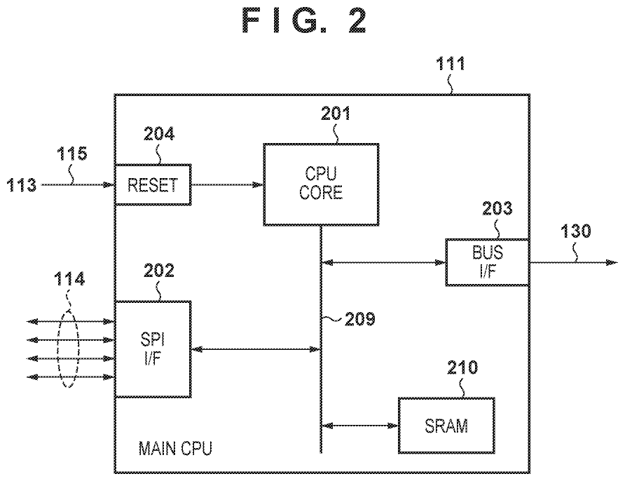

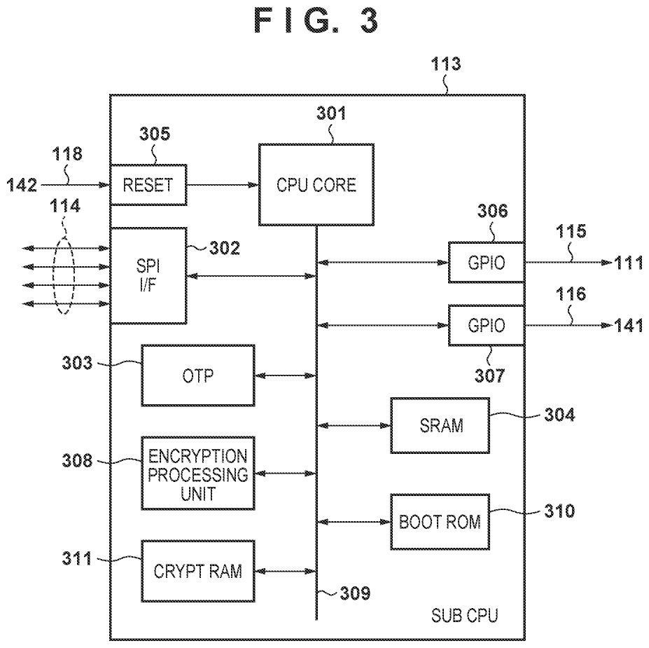

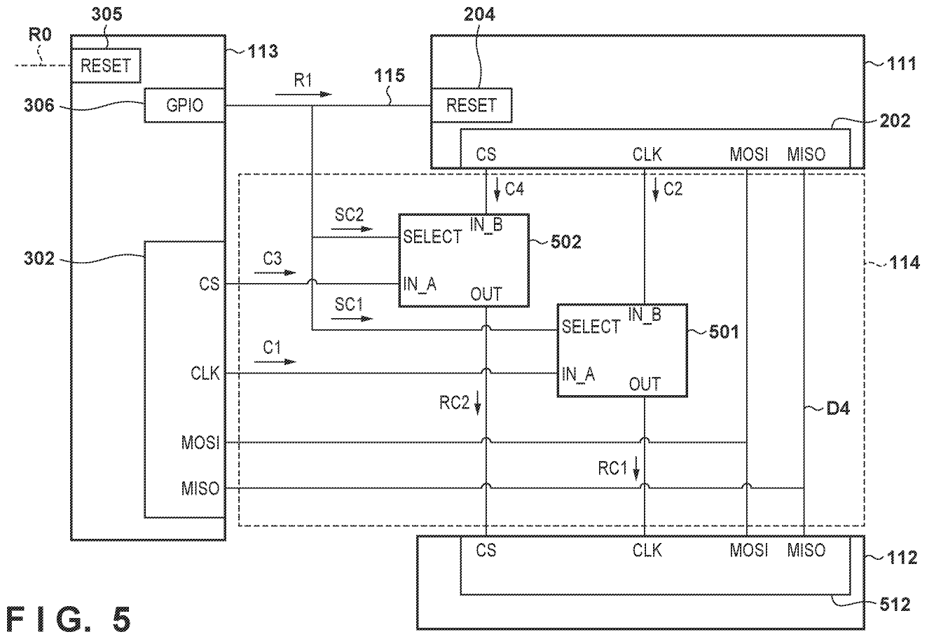

The main CPU 111 is connected to the flash ROM 112 via an SPI (Serial Peripheral Interface) bus 114. Similarly, the sub-CPU 113 is also connected to the flash ROM 112 via the SPI bus 114. Although not shown in FIG. 1, the SPI bus 114 includes a bus switch that selectively outputs, to the flash ROM 112, one of a control signal output from the main CPU 111 and a control signal output from the sub-CPU 113. In addition, the sub-CPU 113 is connected to the main CPU 111 via a reset signal line 115, to an LED (Light Emitting Diode) 141 via an LED signal line 116, and to a reset circuit 142 via a reset signal line 118. An example of the more detailed arrangement of the main CPU 111 will further be described later with reference to FIG. 2. An example of the more detailed arrangement of the sub-CPU 113 will further be described later with reference to FIG. 3. The connection relationship among the main CPU 111, the flash ROM 112, and the sub-CPU 113 by centering the SPI bus 114 will further be described later with reference to FIG. 5.

Referring to FIG. 1, the MFP 1 further includes a DRAM 122, an operation unit 123, an operation I/F 124, a network I/F 125, a printer 126, a scanner 127, a FAX 128, the HDD 129, an image processing unit 131, and a power supply control unit 132.

The DRAM 122 is a main storage device for the main CPU 111, and temporarily stores a program to be executed by the main CPU 111 and associated data. The operation unit 123 is a unit that provides a user interface for an operation of the MFP 1 by the user. When, for example, the operation unit 123 accepts a user operation such as a pressing of a button or a touch on a touch panel, it transmits a corresponding operation signal to the main CPU 111 via the operation I/F 124. The operation unit 123 also displays information for an operation on a display, for example. The operation interface (I/F) 124 is an interface for connecting the operation unit 123 to a signal bus 130. The network I/F 125 is an interface that mediates communication between the MFP 1 and an external apparatus. The network I/F 125 may be, for example, a LAN (Local Area Network) interface. The printer 126 is a unit that prints, on a sheet, an image expressed by image data. The scanner 127 is a unit that optically reads an image on an original or a sheet, converts an optical signal into an electrical signal, and generates scan image data. The facsimile (FAX) 128 is a unit that is connected to a public network to perform facsimile communication with an external facsimile apparatus. The HDD (Hard Disk Drive) 129 is a so-called secondary storage device. The HDD 129 stores data to be used by various functions of the MFP 1 and a program, among the programs executed by the main CPU 111, that does not require validity verification by the sub-CPU 113. The HDD 129 may be used as a spool area for spooling a print job and a scan job and a save area for saving scan image data for reuse. The signal bus 130 is a signal line that interconnects the main CPU 111, the DRAM 122, the operation I/F 124, the network I/F 125, the printer 126, the scanner 127, the FAX 128, the HDD 129, the image processing unit 131, and the power supply control unit 132.

The image processing unit 131 is a processing module that converts image data of a print job received via the network I/F 125 into image data suitable for printing by the printer 126. The image processing unit 131 can also execute image processing such as noise removal, color space conversion, rotation, and data compression for scan image data read by the scanner 127. Furthermore, the image processing unit 131 may execute an arbitrary kind of image processing for image data stored in the HDD 129. The power supply control unit 132 controls supply of power via a power line (not shown) to one or more modules in the MFP 1. The LED 141 notifies, through a state of lighting of a light, the user of a status of verification of validity of a program by the sub-CPU 113. Upon power-on of the MFP 1, the reset circuit 142 outputs a disablement control signal for ceasing disablement (reset) state of the sub-CPU 113 to the reset terminal of the sub-CPU 113.

### 1-2. Example of Arrangement of Main CPU

FIG. 2 is a block diagram showing an example of a practical arrangement of the main CPU 111 according to an embodiment. Referring to FIG. 2, the main CPU 111 includes a CPU core 201, an SPI I/F 202, a bus I/F 203, a reset terminal 204, a signal bus 209, and an SRAM 210.

The CPU core 201 is a processor core that executes calculation for performing the functions of the main CPU 111. The SPI I/F 202 is an interface that mediates communication between the main CPU 111 and another SPI device via the SPI bus 114. The bus I/F 203 is an interface that mediates communication between the main CPU 111 and another module via the signal bus 130. The reset terminal 204 is a terminal to which the reset signal line 115 for conveying a disablement control signal (reset signal) output from the sub-CPU 113 is connected. The signal bus 209 interconnects the CPU core 201, the SPI I/F 202, the bus I/F 203, and the SRAM 210. The SRAM 210 is a so-called cache memory of the main CPU 111, and can be used as a work memory for calculation by the CPU core 201.

In this embodiment, while the disablement control signal input to the reset terminal 204 indicates “Lo”, the main CPU 111 is maintained in a disablement state (reset state), and does not substantially operate in the meantime. When the level of the disablement control signal is switched to “Hi”, the main CPU 111 starts operating. At the beginning of the operation, the CPU core 201 accesses the flash ROM 112 via the SPI bus 114 to read out a program stored at a predetermined address in the flash ROM 112 into the SRAM 210, and then executes the readout program. The program executed here is a boot program for booting the main CPU 111, and can be, for example, a BIOS.

### 1-3. Example of Arrangement of Sub-CPU

FIG. 3 is a block diagram showing an example of a practical arrangement of the sub-CPU 113 according to an embodiment. Referring to FIG. 3, the sub-CPU 113 includes a CPU core 301, an SPI I/F 302, an OTP 303, an SRAM 304, a reset terminal 305, general-purpose input/output terminals 306 and 307, an encryption processing unit 308, a signal bus 309, a boot ROM 310, and a crypt RAM 311.

The CPU core 301 is a processor core that executes calculation for performing the functions of the sub-CPU 113. The SPI I/F 302 is an interface that mediates communication between the sub-CPU 113 and another SPI device via the SPI bus 114. The OTP (One Time Programmable) 303 is a memory area in which data can be written only once at the time of manufacturing and cannot be rewritten. In this embodiment, the address of a Tag (to be described later) and an encrypted hash value obtained by encrypting a hash value of a firmware of the sub-CPU 113 by a public key may be written in advance in the OTP 303. The SRAM 304 is a so-called cache memory of the sub-CPU 113, and can be used as a work memory for calculation by the CPU core 301. The reset terminal 305 is a terminal to which the reset signal line 118 for conveying a disablement control signal (reset signal) output from the reset circuit 142 is connected. The first general-purpose input/output terminal (GPIO) 306 is a terminal to which the reset signal line 115 is connected. The second general-purpose input/output terminal (GPIO) 307 is a terminal to which the LED signal line 116 is connected. The encryption processing unit 308 is a processor that is dedicated to encryption-related processing and supports verification of validity of one or more programs by the sub-CPU 113. For example, the encryption processing unit 308 reconstructs an original hash value by decrypting the encrypted hash value of the firmware of the sub-CPU 113. In addition, the encryption processing unit 308 reconstructs an original hash value by decrypting the encrypted hash value of the boot program of the main CPU 111. The signal bus 309 interconnects the CPU core 301, the SPI I/F 302, the OTP 303, the SRAM 304, the first general-purpose input/output terminal 306, the second general-purpose input/output terminal 307, the encryption processing unit 308, the boot ROM 310, and the crypt RAM 311. The boot ROM 310 is a storage device that stores in advance the boot program (to be also referred to as the boot code hereinafter) of the sub-CPU 113. The crypt RAM 311 is a memory that is dedicated to encryption-related processing and temporarily stores data processed by the encryption processing unit 308 and required to have high confidentiality.

While the disablement control signal input to the reset terminal 305 indicates “Lo”, the sub-CPU 113 is maintained in a disablement state (reset state), and does not substantially operate in the meantime. When the level of the disablement control signal is switched to “Hi”, the sub-CPU 113 starts operating. At the beginning of the operation, the CPU core 301 reads out the boot program stored in the boot ROM 310 into the SRAM 304, and then executes the readout boot program.

### 1-4. Contents of Flash ROM

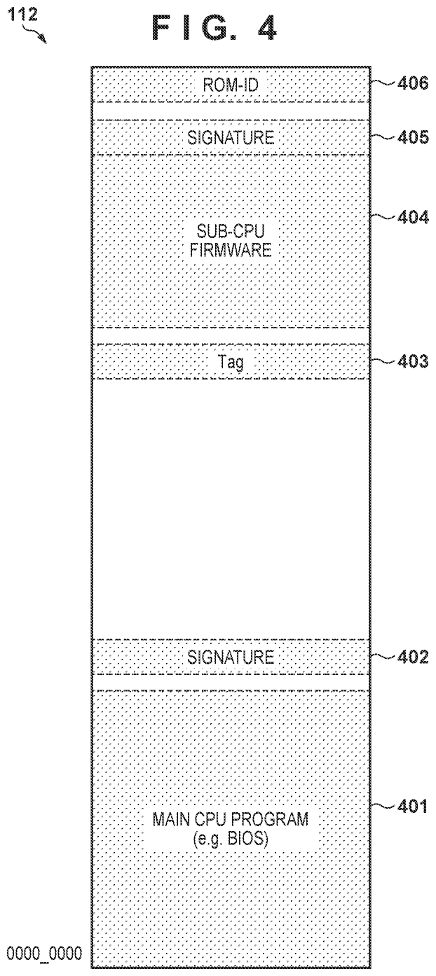

FIG. 4 is an explanatory view showing an example of a memory map of the flash ROM 112 according to an embodiment. As shown in FIG. 4, the flash ROM 112 stores in advance a main CPU program 401, a signature 402, a Tag 403, sub-CPU firmware 404, a signature 405, and a ROM-ID 406. The main CPU program 401 is, for example, a BIOS program to be executed to boot the main CPU 111. The signature 402 is a signature (for example, an RSA signature) for validity verification of the main CPU program 401. The signature 402 can be derived in advance by encrypting a hash value of the (valid) main CPU program 401, and stored in the flash ROM 112. The Tag 403 is data indicating the start address of a storage area in which the sub-CPU firmware 404 is stored. The address of the Tag 403 is stored in the OTP 303, as described above. The sub-CPU firmware 404 is firmware including a program code to be executed by the CPU core 301. The signature 405 is a signature (for example, an ECDSA signature) for validity verification of the sub-CPU firmware 404. The signature 405 can be derived in advance based on the overall (valid) sub-CPU firmware 404 or a specific portion at the beginning of the (valid) sub-CPU firmware 404, and stored in the flash ROM 112. The ROM-ID 406 is data including the start address of a storage area in which the main CPU program 401 is stored, the size of the storage area, and the address of the signature 402.

FIG. 4 shows an example in which only one set of a signature and a program for the main CPU is stored. However, the MFP 1 is not limited to this and a plurality of sets of signatures and programs for the main CPU may be stored. In this case, the main CPU can execute a program selected as needed. Similarly, FIG. 4 shows an example in which only one set of a signature and firmware for the sub CPU is stored. However, the MFP 1 is not limited to this, and a plurality of sets of signatures and pieces of firmware for the sub CPU may be stored. As an example, an example in which the signature 402 is the RSA signature and the signature 405 is the ECDSA signature has been explained. However, each signature may be based on any kind of digital signature scheme such as an RSA signature, a DSA signature, or an ECDSA signature.

### 1-5. Example of Arrangement of SPI Bus

FIG. 5 is a block diagram showing an example of a detailed arrangement of the SPI bus 114 according to an embodiment. FIG. 5 shows the SPI I/F 202 of the main CPU 111, the SPI I/F 302 of the sub-CPU 113, and an SPI I/F 512 of the flash ROM 112. The SPI bus 114 is a set of signal lines that interconnect these SPI I/Fs.

SPI is a kind of synchronous communication scheme for serial communication between integrated circuits. The basic architecture of the SPI bus is formed from four signal lines each of which connects a master device and a slave device. Two of the signal lines are used to transfer a clock signal and a slave selection signal (to be also referred to as a CS (Chip Selection) signal hereinafter), respectively. The remaining two signal lines are used to transfer a data signal (SIMO (Slave In, Master Out)) from a master device to a slave device and a data signal (MISO (Master In, Slave Out)) from a slave device to a master device, respectively. A master device supplies the clock signal to slave devices while indicating to select a slave device to communicate with by asserting the slave selection signal. Then, in accordance with the clock signal and the slave selection signal, data is transmitted from the master device to the selected slave device or from the selected slave device to the master device. The following description of this embodiment assumes SPI communication using the four signal lines. However, in another embodiment, the technique according to the present disclosure may be applied to another architecture formed from more (or less) signal lines. For example, there is also known a Quad SPI communication with additional two signal lines for data signal transmission in addition to the above-described four signal lines (using six signal lines in total). The technique according to the present disclosure is also applicable to such Quad SPI communication.

In the example shown in FIG. 5, the main CPU 111 (SPI I/F 202) and the sub-CPU 113 (SPI I/F 302) serve as master devices. The flash ROM 112 (SPI I/F 502) serves as a slave device. Each of the master-side SPI I/Fs 202 and 302 includes a clock signal terminal (CLK), a slave selection signal terminal (CS), a data output terminal (MOSI), and a data input terminal (MISO). The slave-side SPI I/F 512 includes a clock signal terminal (CLK), a slave selection signal terminal (CS), a data input terminal (MOSI), and a data output terminal (MISO).

When reading out the sub-CPU firmware 404 and another data from the flash ROM 112, the sub-CPU 113 asserts a slave selection signal C3 via the slave selection signal terminal of itself while outputting a clock signal C1 via the clock signal terminal of itself. On the other hand, when reading out the main CPU program 401 from the flash ROM 112, the main CPU 111 asserts a slave selection signal C4 via the slave selection signal terminal of itself while outputting a clock signal C2 via the clock signal terminal of itself.

If the signal line for input to one control signal terminal (CLK or CS) of the flash ROM 112 is simply branched and connected to the two master devices, the control signals from the master devices may conflict with each other. In this embodiment, as described above, the main CPU 111 should be maintained in the disablement state by a disablement control signal R1 until verification of validity of a program by the sub-CPU 113 is completed. However, considering the possibility that the main CPU 111 is activated unintentionally, it would not be safe if the control signal from the main CPU 111 can reach the flash ROM 112 any time. In addition, for a design reason, each of chips used to implement the main CPU 111 and the sub-CPU 113 may not be a chip for which the state of a terminal can be set to high-impedance state that is neither “Lo” nor “Hi”. From this viewpoint, connecting, to the two master devices, the signal line for input to the single control signal terminal of the flash ROM 112 should be avoided to prevent conflict of signals.

Meanwhile, additional implementation of a controller that actively controls flows of the control signals between the master devices and the slave device is disadvantageous since it excessively increases the circuit scale and increases the manufacturing cost.

In light of the above, as shown in FIG. 5, the technique according to the present disclosure incorporates, in the SPI bus 114, at least one simple bus switch that is controlled by the sub-CPU 113. The bus switch may be incorporated in any of the plurality of signal lines forming the SPI bus, in which conflict of signals should be avoided. In this embodiment, as shown in FIG. 5, a first bus switch 501 is provided for the signal lines for the clock signals and a second bus switch 502 is provided for the signal lines for the slave selection signals.

More specifically, the clock signal terminal (CLK) of the sub-CPU 113 is connected to a first control signal input terminal (IN_A) of the first bus switch 501. The sub-CPU 113 outputs the first control signal C1 as the clock signal from the clock signal terminal to the first control signal input terminal. Furthermore, the slave selection signal terminal (CS) of the sub-CPU 113 is connected to a third control signal input terminal (IN_A) of the second bus switch 502. The sub-CPU 113 outputs the third control signal C3 as the slave selection signal from the slave selection signal terminal to the third control signal input terminal. The data input terminal (MISO) and the data output terminal (MOST) of the sub-CPU 113 are connected to the data output terminal (MISO) and the data input terminal (MOSI) of the flash ROM 112, respectively.

In addition, the clock signal terminal (CLK) of the main CPU 111 is connected to a second control signal input terminal (IN_B) of the first bus switch 501. The main CPU 111 outputs the second control signal C2 as the clock signal from the clock signal terminal to the second control signal input terminal. The slave selection signal terminal (CS) of the main CPU 111 is connected to a fourth control signal input terminal (IN_B) of the second bus switch 502. The main CPU 111 outputs the fourth control signal C4 as the slave selection signal from the slave selection signal terminal to the fourth control signal input terminal. The data input terminal (MISO) of the main CPU 111 is connected to a signal line that connects the data input terminal (MISO) of the sub-CPU 113 and the data output terminal (MISO) of the flash ROM 112. The data output terminal (MOSI) of the main CPU 111 is connected to a signal line that connects the data output terminal (MOST) of the sub-CPU 113 and the data input terminal (MOST) of the flash ROM 112.

A control signal output terminal (OUT) of the first bus switch 501 is connected to the clock signal input terminal (CLK) of the flash ROM 112. The first bus switch 501 serves as a first switching unit that selectively outputs, as a first reading control signal RC1, one of the first control signal C1 and the second control signal C2 to the flash ROM 112.

A control signal output terminal (OUT) of the second bus switch 502 is connected to the slave selection signal input terminal (CS) of the flash ROM 112. The second bus switch 502 serves as a second switching unit that selectively outputs, as a second reading control signal RC2, one of the third control signal C3 and the fourth control signal C4 to the flash ROM 112.

The sub-CPU 113 serves as a determination unit that determines whether a program read out from the flash ROM 112 in accordance with the above-described control signals is valid. The main CPU 111 serves as an execution unit that executes the program read out from the flash ROM 112 in a case where the sub-CPU 113 (that is, the determination unit) determines that the program is valid. The flash ROM 112 serves as a storage unit that stores the program. Note that validity of the program typically indicates validity concerning contents of program data. The contents of the program data may include not only a program code or a program command but also data such as setting values necessary to execute the program. Furthermore, instead of the expression “determine (whether the program is valid)”, another expression such as “verify”, “inspect”, “examine”, or “confirm” may be used. In addition, instead of the expression “it is determined that the program is valid (not valid)”, another expression such as “it is found by verification that the program is valid (not valid)” may be used.

As described above with reference to FIGS. 1 to 3, the first general-purpose input/output terminal (GPIO) 306 of the sub-CPU 113 is connected to the reset terminal 204 of the main CPU 111 via the reset signal line 115. A control input terminal (SELECT) of the first bus switch 501 is connected to the reset signal line 115. A control input terminal (SELECT) of the second bus switch 502 is also connected to the reset signal line 115. That is, in this embodiment, the disablement control signal R1 output from the first general-purpose input/output terminal 306 of the sub-CPU 113 is input as a switching instruction signal SC1 to the first bus switch 501, and input as a switching instruction signal SC2 to the second bus switch 502.

Depending on a state of the switching instruction signal SC1, the first bus switch 501 outputs, as the first reading control signal RC1, one of the first control signal C1 from the sub-CPU 113 and the second control signal C2 from the main CPU 111 to the flash ROM 112. Table 1 below is a truth table showing a switching control rule of the first reading control signal RC1 based on a state of the switching instruction signal SC1 in the first bus switch 501.

TABLE 1
Example of Switching Control Rule in Bus Switch

| Switching Instruction Signal | Reading Control Signal |
|---|---|
| SELECT = “Lo” | OUT = IN_A |
| SELECT = “Hi” | OUT = IN_B |

As shown in Table 1, in this embodiment, if the switching instruction signal SC1 indicates “Lo”, the first bus switch 501 connects the first control signal input terminal (IN_A) to the control signal output terminal (OUT). This causes the first control signal C1 input at the first control signal input terminal (IN_A) from the sub-CPU 113 to be output as the first reading control signal RC1 from the control signal output terminal (OUT) to the flash ROM 112. If the switching instruction signal SC1 indicates “Hi”, the first bus switch 501 connects the second control signal input terminal (IN_B) to the control signal output terminal (OUT). This causes the second control signal C2 input at the second control signal input terminal (IN_B) from the main CPU 111 to be output as the first reading control signal RC1 from the control signal output terminal (OUT) to the flash ROM 112. As described above, the first control signal C1, the second control signal C2, and the first reading control signal RC1 are SPI clock signals.

Depending on a state of the switching instruction signal SC2, the second bus switch 502 outputs, as the second reading control signal RC2, one of the third control signal C3 from the sub-CPU 113 and the fourth control signal C4 from the main CPU 111 to the flash ROM 112. The switching control rule of the second reading control signal RC2 based on a state of the switching instruction signal SC2 in the second bus switch 502 may be similar to that shown in Table 1.

That is, in this embodiment, if the switching instruction signal SC2 indicates “Lo”, the second bus switch 502 connects the third control signal input terminal (IN_A) to the control signal output terminal (OUT). This causes the third control signal C3 input at the third control signal input terminal (IN_A) from the sub-CPU 113 to be output as the second reading control signal RC2 from the control signal output terminal (OUT) to the flash ROM 112. If the switching instruction signal SC2 indicates “Hi”, the second bus switch 502 connects the fourth control signal input terminal (IN_B) to the control signal output terminal (OUT). This causes the fourth control signal C4 input at the fourth control signal input terminal (IN_B) from the main CPU 111 to be output as the second reading control signal RC2 from the control signal output terminal (OUT) to the flash ROM 112. As described above, the third control signal C3, the fourth control signal C4, and the second reading control signal RC2 are SPI slave selection signals.

As describe above, the sub-CPU 113 outputs the switching instruction signals SC1 and SC2 to the first bus switch 501 and the second bus switch 502, respectively, thereby controlling switching of the control signals in the first bus switch 501 and the second bus switch 502. Therefore, in this embodiment, it is unnecessary to provide an additional controller for switching control in the SPI bus. The first bus switch 501 and the second bus switch 502 may be simple electric circuits.

Furthermore, depending on a result of determination of whether the program read out from the flash ROM 112 is valid, the sub-CPU 113 decides values of the switching instruction signals SC1 and SC2. Especially, the sub-CPU 113 can maintain the value of each switching instruction signal to be “Lo” in accordance with Table 1 so as to prevent a signal from the main CPU 111 having been unintentionally activated from reaching the flash ROM 112 before it is determined that the program is valid.

In this embodiment, as shown in the example of FIG. 5, since the switching instruction signals SC1 and SC2 are configured to be identical with the disablement control signal R1, no additional terminal for switching control is required in the sub-CPU 113.

### 1-6. Examples of Timings of Control Signals

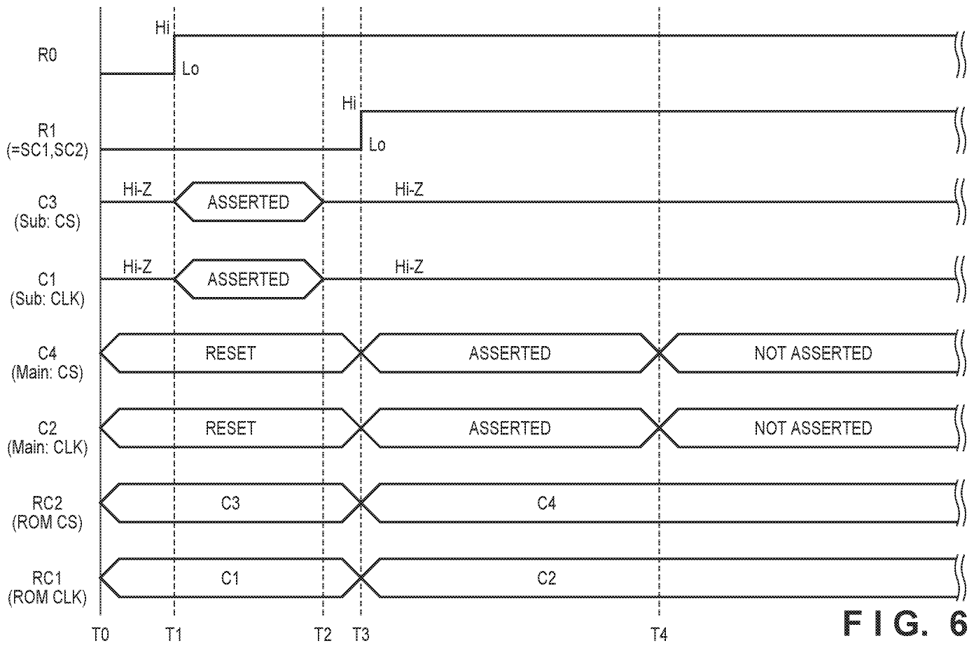

FIG. 6 is a timing chart showing flows of the control signals on the SPI bus 114 according to an embodiment. As an example, the SPI I/F 202 of the main CPU 111 is implemented by a chip having only a terminal that cannot be set to a high-impedance state. On the other hand, the terminal of the SPI I/F 302 of the sub-CPU 113 can be set to a high-impedance state. Note that the technique according to the present disclosure is not limited to such examples of the chips.

In FIG. 6, the abscissa represents time. On the ordinate, a signal R0 shown at the uppermost level is a disablement control signal for the sub-CPU 113, and the signal R1 shown at the second level is a disablement control signal for the main CPU 111. At the third and subsequent levels, the third control signal C3, the first control signal C1, the fourth control signal C4, the second control signal C2, the second reading control signal RC2, and the first reading control signal RC1 are shown in order from the upper side.

At time T0, the MFP 1 is powered on. During a period from time T0 to time T1, the disablement control signal R0 indicates “Lo”. Therefore, the sub-CPU 113 is in the disablement state. In the example shown in FIG. 6, while the sub-CPU 113 is in the disablement state, it outputs the disablement control signal R1 indicating “Lo”. Since the switching instruction signals SC1 and SC2 are the same as the disablement control signal R1, they indicate “Lo”. During this period, the first control signal C1 and the third control signal C3 of the sub-CPU 113 can be maintained in the high-impedance (Hi-Z) state (or may indicate “Lo” depending on the specification of the chip). Since the disablement control signal R1 indicates “Lo”, the main CPU 111 is also in the disablement (RESET) state. The first bus switch 501 selects the first control signal C1 as the first reading control signal RC1 but the first control signal C1 is in the high-impedance state. The second bus switch 502 selects the third control signal C3 as the second reading control signal RC2 but the third control signal C3 is also in the high-impedance state. In the high-impedance state, a signal value is particularly meaningless.

At time T1, the disablement control signal R0 is switched to “Hi”, and disablement of the sub-CPU 113 is ceased. The disablement control signal R1 still indicates “Lo”. Therefore, the main CPU 111 is kept unchanged from the disablement state. The first bus switch 501 selects the first control signal C1 as the first reading control signal RC1, and outputs the first control signal C1 to the clock signal input terminal of the flash ROM 112. Similarly, the second bus switch 502 selects the third control signal C3 as the second reading control signal RC2, and outputs the third control signal C3 to the slave selection signal input terminal of the flash ROM 112.

During a period from time T1 to time T2, the sub-CPU 113 asserts the third control signal C3 as the slave selection signal while asserting the first control signal C1 to output a clock. Then, in accordance with the first and third control signals C1 and C3, the program stored in the flash ROM 112 is read out from the data output terminal of the flash ROM 112 to the data input terminal of the sub-CPU 113. The sub-CPU 113 determines whether the program thus read out from the flash ROM 112 is valid.

At time T2, the reading operation of the program from the flash ROM 112 by the sub-CPU 113 ends. After time T2, the sub-CPU 113 sets the first control signal C1 and the third control signal C3 in the high-impedance state, as shown in FIG. 6. The sub-CPU 113 maintains the value of the disablement control signal R1 at “Lo” until time T3 at which it is determined that the program to be executed by the main CPU 111 is valid. Therefore, during a period from time T0 to time T3, the main CPU 111 is in the disablement state. During this period, the first bus switch 501 and the second bus switch 502 do not transfer the signal from the main CPU 111 to the flash ROM 112. Thus, even if the main CPU 111 asserts a control signal without an intention of the developer, the control signal does not cause a conflict, and does not influence the operation of the MFP 1.

At time T3, verification of validity of the program by the sub-CPU 113 is completed. Assume that it is determined that the program read out from the flash ROM 112 is valid. At time T3, the sub-CPU 113 switches the state of the disablement control signal R1 to “Hi”, thereby ceasing disablement of the main CPU 111. At the same time, the states of the switching instruction signals SC1 and SC2 are also switched to “Hi”. Therefore, the first bus switch 501 selects the second control signal C2 as the first reading control signal RC1, and outputs the second control signal C2 to the clock signal input terminal of the flash ROM 112. Similarly, the second bus switch 502 selects the fourth control signal C4 as the second reading control signal RC2, and outputs the fourth control signal C4 to the slave selection signal input terminal of the flash ROM 112.

During a period from time T3 to time T4, the main CPU 111 asserts the fourth control signal C4 as the slave selection signal while asserting the second control signal C2 to output a clock. Then, in accordance with the second and fourth control signals C2 and C4, the program stored in the flash ROM 112 is read out from the data output terminal of the flash ROM 112 to the data input terminal of the main CPU 111. The main CPU 111 executes the program thus read out from the flash ROM 112.

At time T4, the reading operation of the program from the flash ROM 112 by the main CPU 111 ends. After time T4, the sub-CPU 113 continuously maintains the value of the disablement control signal R1 (switching instruction signals SC1 and SC2) at “Hi”. Thus, the first bus switch 501 selects the second control signal C2 as the first reading control signal RC1, and the second bus switch 502 selects the fourth control signal C4 as the second reading control signal RC2. However, the main CPU 111 need not assert the second control signal C2 and the fourth control signal C4 unless it is required again to read out data from the flash ROM 112.

### <2. Example of Procedure of Processing>>

### 2-1. Schematic Procedure

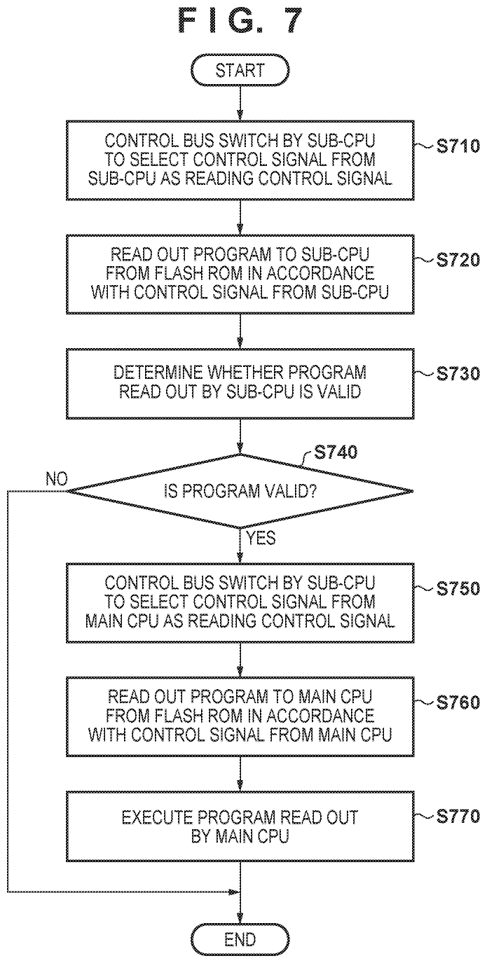

FIG. 7 is a flowchart illustrating an example of a schematic procedure of control processing for controlling execution of a program in an information processing apparatus (for example, the MFP 1) according to an embodiment. The processing shown in FIG. 7 is mainly executed by the sub-CPU (determination unit) 113, the main CPU (execution unit) 111, the first bus switch (first switching unit) 501, the second bus switch (second switching unit) 502, and the flash ROM (storage unit) 112 of the MFP 1. Note that in the following description, a processing step is abbreviated to S (step).

In S710, the sub-CPU 113 controls a bus switch to select, as a reading control signal, a control signal from the sub-CPU 113 by outputting a switching instruction signal indicating a second value (for example, “Lo”) to the bus switch. For example, the sub-CPU 113 controls the first bus switch 501 to select the first control signal C1 as the first reading control signal RC1 by outputting the switching instruction signal SC1 to the first bus switch 501. At the same time, the sub-CPU 113 controls the second bus switch 502 to select the third control signal C3 as the second reading control signal RC2 by outputting the switching instruction signal SC2 to the second bus switch 502.

Next, in S720, the sub-CPU 113 reads out a program from the flash ROM 112 in accordance with the reading control signals output from the bus switches to the flash ROM 112. For example, the first control signal C1 is output, as the first reading control signal RC1, from the first bus switch 501 to the flash ROM 112, and the third control signal C3 is output, as the second reading control signal RC2, from the second bus switch 502 to the flash ROM 112. The program read out in accordance with the control signals can include a boot program to be executed by the main CPU 111.

Next, in S730, the sub-CPU 113 determines whether the program read out in S720 is valid. For example, if a hash value calculated from the program data of the program read out from the ROM is equal to a hash value reconstructed from the signature of the program, the sub-CPU 113 can determine that the program is valid. On the other hand, if the hash value calculated from the program data is not equal to the hash value reconstructed from the signature, the sub-CPU 113 can determine that the program is not valid. The fact that the program is not valid means that, for example, the program has changed without an intention of a valid developer due to alteration or deterioration.

After that, the process branches in S740 depending on the result of the validity determination processing in S730. If it is determined that the program is valid, the process advances to S750; otherwise, the process ends by skipping operations in S750 to S770.

In S750, the sub-CPU 113 controls the bus switch to select, as a reading control signal, the control signal from the main CPU 111 by outputting a switching instruction signal indicating a first value (for example, “Hi”) to the bus switch. For example, the sub-CPU 113 controls the first bus switch 501 to select the second control signal C2 as the first reading control signal RC1 by outputting the switching instruction signal SC1 to the first bus switch 501. At the same time, the sub-CPU 113 controls the second bus switch 502 to select the fourth control signal C4 as the second reading control signal RC2 by outputting the switching instruction signal SC2 to the second bus switch 502.

Next, in S760, the main CPU 111 reads out the program from the flash ROM 112 in accordance with the reading control signals output from the bus switches to the flash ROM 112. For example, the second control signal C2 is output, as the first reading control signal RC1, from the first bus switch 501 to the flash ROM 112, and the fourth control signal C4 is output, as the second reading control signal RC2, from the second bus switch 502 to the flash ROM 112. The program read out in accordance with the control signals can include the boot program of the main CPU 111, which has been determined to be valid by the sub-CPU 113.

Next, in S770, the main CPU 111 executes the program read out in S760. For example, the main CPU 111 securely initializes and activates the various functions of the MFP 1 described with reference to FIG. 1 by executing the boot program (for example, a BIOS) determined to be valid by the sub-CPU 113.

### 2-2. Processing of Sub-CPU

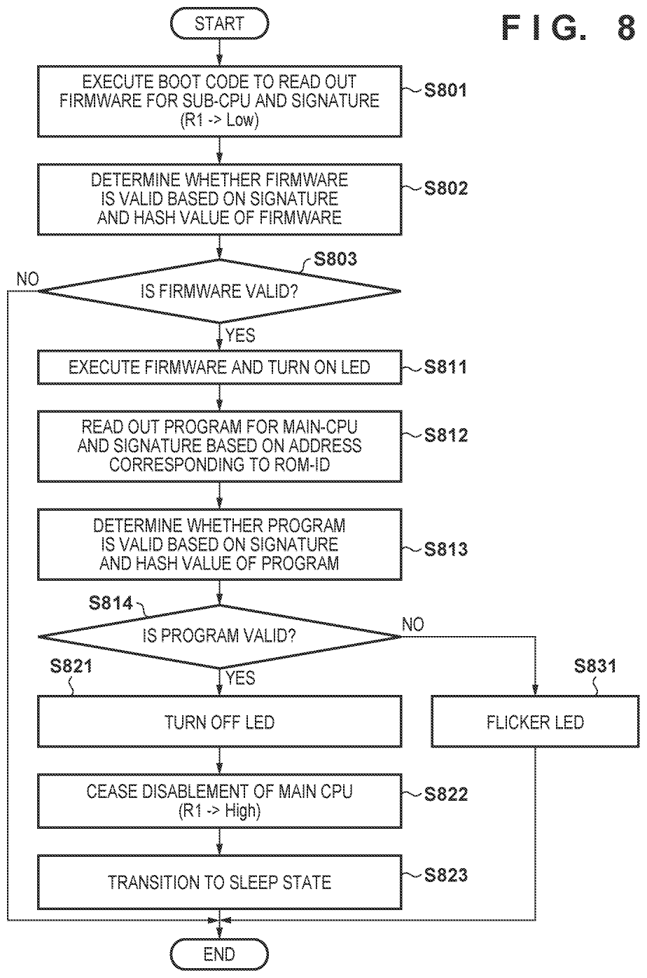

FIG. 8 is a flowchart illustrating an example of a detailed procedure of control processing executed by the sub-CPU according to an embodiment.

S801 can correspond to time T1 in the timing chart of FIG. 6. In S801, in response to cessation of disablement by the reset circuit 142, the sub-CPU 113 executes the boot code in the boot ROM 310 to read out the firmware and signature for the sub-CPU 113 into the SRAM 304.

Next, in S802, based on a hash value reconstructed from the readout signature and a hash value derived from the program data of the firmware, the sub-CPU 113 determines whether the firmware is valid. For example, the encryption processing unit 308 of the sub-CPU 113 decrypts the signature 405 by the public key in the OTP 303, thereby acquiring a correct hash value. The encryption processing unit 308 also calculates the hash value of the firmware 404 using a predetermined hash function. The determination processing in S802 can be performed based on comparison of these hash values.

After that, the process branches in S803 depending on the result of the validity determination processing in S802. If it is determined that the firmware is valid, the process advances to S811; otherwise, the process ends by skipping operations in S811 and subsequent steps.

In S811, the sub-CPU 113 executes the valid firmware read out into the SRAM 304. For example, the sub-CPU 113 can output a status signal from the second general-purpose input/output terminal 307 to the LED 141 to turn on the LED 141.

Next, in S812, the sub-CPU 113 reads out the main CPU program and the signature from the flash ROM 112 into the SRAM 304 using an address derived based on the ROM-ID 406 in the flash ROM 112.

Next, in S813, based on a hash value reconstructed from the readout signature and a hash value derived from the program data of the main CPU program, the sub-CPU 113 determines whether the main CPU program is valid. For example, the encryption processing unit 308 of the sub-CPU 113 decrypts the signature 402 by the public key embedded in the firmware 404, thereby acquiring a correct hash value. The encryption processing unit 308 also calculates the hash value of the main CPU program 401 using a predetermined hash function. The determination processing in S813 can be performed based on comparison of these hash values.

After that, the process branches in S814 depending on the result of the validity determination processing in S813. If it is determined that the main CPU program is valid, the process advances to S821; otherwise, the process advances to S831.

S821 can correspond to time T2 in the timing chart of FIG. 6. In S821, for example, the sub-CPU 113 can output a status signal from the second general-purpose input/output terminal 307 to the LED 141 to turn off the LED 141.

S822 can correspond to time T3 in the timing chart of FIG. 6. In S822, the sub-CPU 113 outputs, to the main CPU 111, the disablement control signal R1 set to “Hi”, thereby ceasing disablement of the main CPU. The disablement control signal R1 is also output to the first bus switch 501 and the second bus switch 502 as the switching instruction signals SC1 and SC2, respectively.

Next, in S823, the sub-CPU 113 may transition to a sleep state to save power consumption. Even in the sleep state, the sub-CPU 113 continues outputting the disablement control signal R1 (and the switching instruction signals SC1 and SC2) set to “Hi”. Note that if the sub-CPU 113 is a processor dedicated to program validity determination at the time of system boot, the sub-CPU 113 need not return to a normal state once it has transitioned to the sleep state. On the other hand, if the sub-CPU 113 is reused for a purpose other than validity determination, the sub-CPU 113 may return to the normal state by receiving an interrupt signal after the transition to the sleep state.

If it is determined that the main CPU program is not valid, the sub-CPU 113 flickers, in S831, the LED 141 by outputting a status signal from the second general-purpose input/output terminal 307 to the LED 141, thereby notifying the user of abnormality of the program. Note that the present disclosure is not limited to the above-described example, and the user may be notified of the validity verification status by an arbitrary lighting pattern of the LED 141.

### 2-3. Processing of Main CPU

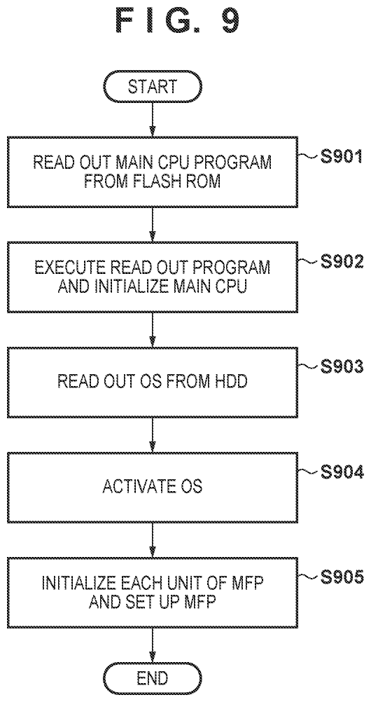

FIG. 9 is a flowchart illustrating an example of a detailed procedure of control processing executed by the main CPU according to an embodiment.

S901 can correspond to time T3 in the timing chart of FIG. 6. In S901, in response to cessation of disablement via the disablement control signal R1 from the sub-CPU 113, the main CPU 111 reads out the main CPU program from the flash ROM 112 into the DRAM 122.

Next, in S902, the main CPU 111 initializes the various functions of the main CPU 111 including the input/output function by executing the readout main CPU program.

Next, in S903, the main CPU 111 reads out the program data of the operating system (OS) from the HDD 129 into the DRAM 122.

Next, in S904, the main CPU 111 activates the operating system by executing the readout program data.

Next, in S905, the main CPU 111 initializes the operation unit 123, the operation I/F 124, the network I/F 125, the printer 126, the scanner 127, the FAX 128, and the image processing unit 131, thereby setting up the MFP 1 into a state in which the user can use the MFP 1.

### <3. Summary>>

In the above-described embodiment, the first switching unit selectively outputs, to the storage unit storing a program, one of the first control signal output from the determination unit that determines validity of the program and the second control signal output from the execution unit that executes the program. The determination unit controls selective switching of the control signal in the first switching unit. With this arrangement, it is possible to securely verify validity of the program by avoiding conflict of the control signals from the plurality of processors while suppressing an increase in circuit scale and an increase in manufacturing cost.

In the above-described embodiment, the determination unit decides the value of the switching instruction signal output to the first switching unit depending on a result of determination of whether the program is valid. The value of the switching instruction signal is typically set to a value for causing the first switching unit to select the first control signal until it is determined that the program is valid. Then, in response to determination that the program is valid, the value of the switching instruction signal is switched to a value for causing the first switching unit to select the second control signal. With this arrangement, it is possible to implement a mechanism for preventing conflict of the control signals among the plurality of processors using a bus switch as a simple electric circuit (or a transistor, an FET, or an arbitrary logic circuit, which has a similar function) at a low cost.

In the above-described embodiment, the execution unit is a processor that controls the information processing apparatus, and the program includes a boot program such as a BIOS for booting the processor. As described above, by applying the technique according to the present disclosure to the boot of the information processing apparatus or system, it is possible to efficiently construct a secure boot mechanism robust to a risk such as alteration or deterioration of the program.

In the above-described embodiment, the disablement control signal for ceasing disablement of the execution unit in response to determination that the program is valid is identical with the switching instruction signal for switching the output from the first switching unit to the second control signal. With this arrangement, it is possible to switch the flow of the control signal at an appropriate timing without excessively increasing signal lines or terminals in the apparatus.

In the above-described embodiment, the determination unit and the execution unit serve as mater devices in a synchronous communication scheme, and the storage unit serves as a slave device in the synchronous communication scheme. By applying the technique according to the present disclosure to the synchronous communication scheme having a master-slave architecture, it is possible to readily realize management of an access order when accessing from a plurality of master devices to one slave device. For example, even if another master device which should operate after completion of operation of a given master device is activated at an earlier timing against intention, it is possible to prevent such another master device from interfering with the operation of the given master device.

In the above-described embodiment, the control signal may include at least the clock signal or the slave selection signal in the synchronous communication scheme. Therefore, the above-described embodiment is satisfactorily suitable for SPI as a synchronous serial communication scheme adopted in many information processing apparatuses.

In the above-described embodiment, while the first switching unit switches an output source of the clock signal between the determination unit and the execution unit, the second switching unit switches an output source of the slave selection signal between the determination unit and the execution unit. The determination unit also controls selective switching of the control signal in the second switching unit. With this arrangement, it is possible to appropriately avoid conflict of the signals among the plurality of mater devices with respect to both the clock signal and the slave selection signal output from the mater devices to the slave device.

In the above-described embodiment, at least one of the first control signal output from the determination unit and the second control signal output from the execution unit may be output from a terminal that cannot be set to the high-impedance state. In this case as well, since an output of a control signal from the determination unit or the execution unit at a timing when it should not actually be output is blocked by the corresponding switching unit, the output signal level from each unit is prevented from interfering with the overall operation of the apparatus. As described above, the technique according to the present disclosure makes it possible to construct an information processing apparatus or system at a low cost by flexibly using a simple or low-end chip other than chips whose terminals are each able to be set to the high-impedance state.

### 4. Modifications

The present invention is not limited to the above-described embodiments, and various modifications can be made. For example, in the above-described embodiments, an application example has mainly explained where they are applied to the MFP 1 including the main CPU and the sub-CPU. However, in general, the technique according to the present disclosure may be applied to an apparatus including some processors. The program whose validity is determined by the sub-CPU is not limited to that described in the above embodiment, and may include any kind of programs. The terms “main CPU” and “sub-CPU” in this specification do not imply any hierarchical relationship between the two processors. For example, the main CPU and the sub-CPU may be referred to as the first CPU and the second CPU, respectively.

In the above-described embodiment, when explaining the specific states of the control signal, the particular signal levels of “Lo (Low)” and “Hi (High)” are used. However, the signal levels may be inverted. That is, when asserting a given control signal, the control signal may be switched from “Lo” to “Hi” or from “Hi” to “Lo”.

This specification has explained the example in which the programs to undergo validity verification are stored in the flash ROM. However, the programs may be stored in any kind of storage device other than the flash ROM, which is connected to the SPI bus or a similar bus.

### 5. Other Embodiments

Embodiment(s) of the present invention can also be realized by a computer of a system or apparatus that reads out and executes computer executable instructions (e.g., one or more programs) recorded on a storage medium (which may also be referred to more fully as anon-transitory computer-readable storage medium′) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-127088, filed on Jul. 8, 2019 which is hereby incorporated by reference herein in its entirety.

What is claimed is:

1. An information processing apparatus comprising:
a storage configured to store a program;
a first processor configured to output a first control signal, and determine whether the program read out from the storage in accordance with the first control signal is valid;
a second processor configured to output a second control signal, and execute the program read out from the storage in accordance with the second control signal; and
a first switch configured to selectively output one of the first control signal and the second control signal to the storage.

2. The information processing apparatus according to claim 1, wherein
the first switch selectively outputs one of the first control signal and the second control signal to the storage as a first reading control signal, and
the first processor controls switching of the first reading control signal in the first switch.

3. The information processing apparatus according to claim 2, wherein
the first processor controls the switching of the first reading control signal in the first switch by outputting a switching instruction signal to the first switch, and
the first processor decides a value of the switching instruction signal depending on a result of the determination of whether the program is valid.

4. The information processing apparatus according to claim 3, wherein
if the first processor determines that the program is valid, the first processor outputs the switching instruction signal indicating a first value to the first switch, and
if the switching instruction signal indicating the first value is input, the first switch selects the second control signal as the first reading control signal.

5. The information processing apparatus according to claim 4, wherein
the first processor outputs the switching instruction signal indicating a second value to the first switch until it is determined that the program is valid, and
if the switching instruction signal indicating the second value is input, the first switch selects the first control signal as the first reading control signal.

6. The information processing apparatus according to claim 5, wherein
the second processor is disabled until the first processor determines that the program is valid, and
if the first processor determines that the program is valid, the first processor outputs, to the second processor, a disablement control signal for ceasing disablement of the second processor.

7. The information processing apparatus according to claim 6, wherein the disablement control signal is the same signal as the switching instruction signal.

8. The information processing apparatus according to claim 1, wherein
the second processor is a processor configured to control the information processing apparatus, and
the program includes a boot program executed when booting the processor.

9. The information processing apparatus according to claim 2, wherein
the first processor and the second processor serve as master devices in a synchronous communication scheme, and
the storage serves as a slave device in the synchronous communication scheme.

10. The information processing apparatus according to claim 9, wherein the first control signal, the second control signal, and the first reading control signal are clock signals in the synchronous communication scheme.

11. The information processing apparatus according to claim 9, wherein the first control signal, the second control signal, and the first reading control signal are slave selection signals in the synchronous communication scheme.

12. The information processing apparatus according to claim 10, wherein
the first processor further outputs a third control signal, and determines whether the program read out from the storage in accordance with the first control signal and the third control signal is valid,
the second processor further outputs a fourth control signal, and executes the program read out from the storage in accordance with the second control signal and the fourth control signal,
the information processing apparatus further includes a second switch configured to selectively output, as a second reading control signal, one of the third control signal and the fourth control signal to the storage,
the first processor further controls switching of the second reading control signal in the second switch, and
the third control signal, the fourth control signal, and the second reading control signal are slave selection signals in the synchronous communication scheme.

13. The information processing apparatus according to claim 12, wherein
the first processor includes
a clock signal terminal connected to a first control signal input terminal of the first switch,
a slave selection signal terminal connected to a third control signal input terminal of the second switch,
a data input terminal connected to a data output terminal of the storage, and
a data output terminal connected to a data input terminal of the storage, and
the second processor includes
a clock signal terminal connected to a second control signal input terminal of the first switch,
a slave selection signal terminal connected to a fourth control signal input terminal of the second switch,
a data input terminal connected to the data output terminal of the storage, and
a data output terminal connected to the data input terminal of the storage.

14. The information processing apparatus according to claim 12, wherein the first processor further includes a general-purpose input/output terminal from which a switching instruction signal for controlling the switching of the first reading control signal in the first switch is output.

15. The information processing apparatus according to claim 1, wherein at least one of the first control signal output from the first processor and the second control signal output from the second processor is output from a terminal that cannot be set to a high-impedance state.

16. A control method for controlling execution of a program in an information processing apparatus,
the information processing apparatus including a storage configured to store the program, a first processor configured to determine whether the program is valid, a second processor configured to execute the program, and a first switch configured to selectively output, to the storage, one of a first control signal output from the first processor and a second control signal output from the second processor,
the method comprising:
controlling, by the first processor, the first switch to output the first control signal to the storage;
determining, by the first processor whether the program read out from the storage in accordance with the first control signal is valid;
controlling, by the first processor, the first switch to output the second control signal to the storage; and
executing, by the second processor, the program read out from the storage in accordance with the second control signal.
